(19) United States
(12) Patent Application Publication
(10) Pub. No.: US 2023/0393075 A1
(43) Pub. Date: Dec. 7, 2023

(54) Combustion Extraction Probe for Sulfur Chemiluminescence Detection

(71) Applicant: Randall Lee Shearer, Broomfield, CO (US)

(72) Inventor: Randall Lee Shearer, Broomfield, CO (US)

(21) Appl. No.: 18/206,247

(22) Filed: Jun. 6, 2023

Related U.S. Application Data
(60) Provisional application No. 63/349,687, filed on Jun. 7, 2022.

(51) Int. Cl. G01N 21/76

(52) U.S. Cl. CPC G01N 21/766

(57) ABSTRACT

This disclosure is directed to an improved extraction probe and method of operation for sampling combustion gases from a furnace or burner for sulfur selective detection. The extraction probe is comprised of at least one constrained reduction zone with at least one discontinuous sampling conduit made from at least one smooth refractory material. The configured assembly allows for controlled formation of species that facilitate transport of sulfur monoxide or its equivalent for enhanced detection and system performance of sulfur chemiluminescence detectors.

### FIELD OF THE INVENTION

This disclosure relates to sampling reactive species from combustion systems especially related to chemical measurements by ozone induced chemiluminescence, and particularly for the detection of sulfur compounds using gas chromatography and sulfur chemiluminescence detection. More particularly, this disclosure relates to improved methods and construction of a combustion apparatus extraction probe used to sample the reactive product gas from an externally heated combustion furnace and its efficient transfer of species for improved detection.

### BACKGROUND OF INVENTION

Gas chromatography (GC) is advantageous for chemical analysis especially due to availability of sensitive universal and selective detectors. By combining excellent separation power of high resolution using capillary columns with a highly sensitive and selective detector, measurement of ultra-trace compounds in increasingly complex sample matrices can be achieved. The augmentation of an analytical method with a selective detector can reduce risk of false positive identifications, as well as minimize the need for time consuming method preparation.

A case in point for this strategy is the analysis of trace sulfur compounds. By far, this is an important and most challenging application, as sulfur compounds can be present in a wide variety of matrices and applications ranging from the production of beverages, catalysis research, environmental monitoring, characterization of fuels and lubricants, to defense applications including the detection of chemical warfare agents and tracking of explosives in anti-terrorism efforts. In general, sulfur compounds are quite reactive. The presence of sulfur compounds, even at parts-per-billion level can have a negative impact on the performance of catalysts, chemical processes, and the quality of both consumer and industrial products. More recently, detection of volatile species, such as organic compounds and nitric oxide in breath appear useful in detection of infections in humans, for example infection by SARS-CoV-2.

Several detectors are useful for sulfur selective measurement as chromatographic detectors, but for the most demanding applications, the sulfur chemiluminescence detector based upon the work and invention of Benner and Stedman (Benner, R., Stedman, H., Universal Sulfur Detection by Chemiluminescence, Anal. Chem., 1989 (61) 1266-1271 and U.S. Pat. No. 5,424,217, Process for Detection of Sulfur) is the heretofore most successful, sensitive and selective gas chromatographic detector for these applications. Two aspects of this are of great importance. Interferences are eliminated by their conversion to non-responding species, such as carbon dioxide and water, and the conversion of sulfur compounds to a highly sensitively detectable sulfur monoxide (SO) species. Very interestingly, this highly sensitive detection principle results from the fact that the formed sulfur species is highly exothermic in its reaction with ozone, resulting in formation of an excited state of sulfur dioxide, emitting a highly detectable wavelength of light.

The history of this development in this area has been recently described in detail by Luong, et al. (Luong, J., Gras, R., Hawryluk, M and Shearer, R., A Brief History and Recent Advances in Ozone Induced Chemiluminescence Detection of Sulfur Compounds by Gas Chromatography, Anal. Methods, 2016, 8, 7014-7024.)

The original Benner and Stedman detector used a burner that was constructed of a large quartz apparatus in which an orifice was used to “quench’ gas phase reactions. While functioning well for measurement of gaseous sulfur species in ambient air, it proved impractical to couple directly to a gas chromatograph because of its size, large gas consumption, need to vent a portion of the sample gas and because of the inconvenient use of a diffusion flame that needed to be ignited externally. It was not capable of accommodating chromatographic peaks because of its required large volume and high gas flow rates. It was not able to tolerate sample streams which might consist of hydrocarbon solvents or minor components that could contain heteroatoms, and the orifice was prone to partial or full blockage from particulates. In addition, it was found that the base-line signal of the device would rise continuously upon operation and interfere with measurements. A continuous addition of a halogen containing species was found to suppress this interference, though the mechanism of the interference had not been elucidated, and due to lower sensitivity attained compared to alumina ceramic based systems, such difficulties thwarted the use of quartz in commercial systems.

While small amounts of this halogen species were readily tolerated on a short time scale, eventually corrosive combustion products would foul downstream components. Attempts at adaptation of a quartz apparatus to chromatography were problematic and unsuccessful because of the aforementioned problems, though the background interference problem was the most limiting.

It is instructive to consider probe sampling of reactive combustion gases, especially from flames. Hori describes typical flame sampling of flame gases using quartz probes (Hori, M., Effects of Probing Conditions on NO₂/NOₓ Ratios, Combustion Science and Technology, 1980, 23, 131-135). Like the Benner apparatus, tips or orifices are used on the inlet of probes in an attempt to stop or quench post flame reactions. A number of parameters, including pressure, cooling rate, surface to volume ratio resulting from geometry play important roles in successful combustion sampling, as defined by preserving reactive species concentrations. The flame stoichiometry also plays a crucial role in this. For a reactive species like nitric oxide (NO) minimizing wall reactions is crucial. This is for example why some probes incorporate the complexity of water cooling.

The background interference observed by Benner and Stedman may result from the formation of silicon monoxide (SiO) which is isovalent to sulfur monoxide (SO) both being from group 6A elements of the periodic table. SiO is in general even more reactive thus explaining the fact that it would chemiluminesce directly with oxygen, i.e., not requiring ozone to produce light.

Godec, Johansen and Stedman found that an alumina (nominally 99.7%) ceramic probe inserted into a Flame Ionization Detector (FID) operated under hydrogen rich conditions could be used to generate sulfur monoxide in a manner similar to that of the quartz burner, also allowing an FID signal to be acquired simultaneously (U.S. Pat. No. 5,330,714, Godec, R., Johansen, N. and Stedman, D., Process and Apparatus for Simultaneous Measurement of Sulfur and Non-sulfur Containing Compounds).

Problems with stability, adjustment and optimization limited the application of the use of this ceramic probe. Further, because of the large amount of hydrogen and air required to maintain the flame, copious amounts of water were generated and leading to operational issues of condensation and pump oil emulsion formation. The FID signal was also made noisy when operated in this manner.

Shearer addressed these problems with the development of an externally heated and entirely enclosed ceramic furnace assembly (U.S. Pat. No. 6,130,095, Method for the Measurement of Sulfur Compounds). This development was termed “Flameless Sulfur Chemiluminescence Detection” because it did not involve an open flame and because the heated ceramic combustion assembly was operated under fuel-rich conditions outside of the flammability limits of hydrogen in air. It was later realized that there is present something akin to a flame/plasma that exhibits ignition behavior; for example, a decrease in pressure (in the balanced reaction, the number of molecules of reactants exceed the number of molecules of products) and a simultaneous rise in background signal is observed corresponding to ignition (resulting from rapid increase in temperature from the combustion reactions). The invention yielded an order of magnitude or greater improvement in response (Shearer, R. L., Development of Flameless Sulfur Chemiluminescence Detection: Application to Gas Chromatography, Anal. Chem., 1992 (64) 2192-2196). As was found by Benner and Stedman, a flame radical species, sulfur monoxide (SO), is intimately involved in the detector's mechanism of operation.

A drawback to this system compared to the Godec, et al., device, is that for the FID response to be obtained simultaneously post-column splitting or two column analysis was required. This resulted in difficulties in optimizing the split or in matching retention times. In 1994 this problem was addressed by Sievers Instruments with its introduction of an FID “adapter” that fitted a deactivated metal restrictor on the base of ceramic combustion assembly that was inserted into the FID exhaust chimney. Application of this device to sulfur simulated distillation was reported (Shearer, R. L. and Meyer, L. M., Simultaneous Measurement of Hydrocarbons and Sulfur Compounds using Flame Ionization and Sulfur Chemiluminescence Detection for Sulfur Simulated Distillation, Journal of High Resolution Chromatography 22(7): 386-390, 1999). A similar approach was described (Chen, Y. C. and Lo, J. G., Gas Chromatography with Flame Ionization and Flameless Sulfur Chemiluminescence Detectors in Series for Dual Channel Detection of Sulfur Compounds, Chromatographia, 1996 (43) 522-526) in which the extractive probe was comprised of ceramic and which utilized an “elevator” to conveniently position the probe and to support the flameless burner. Problems with weight of combustion assembly placed on the FID and loss of a deactivation layer or deposition of silica on restrictor walls gives rise to blockage and active sites. The probe also interrupts gas flow in the FID resulting in ignition difficulty. All of these represent difficulties that require attention.

Another advance in sulfur chemiluminescence detection (SCD) was the development of the “dual plasma” combustion approach in which two chief reaction methods take place in a single combustion furnace (Gras, R., Luong, J, Mustacich, R. and Shearer, R., DP-SCD and LTMGC for Determination of Low Sulfur Levels in Hydrocarbons, Journal of ASTM International 2(7), 2005). The first combustion step involves oxidation of hydrocarbon and sulfur species within an oxygen rich zone and the second step involves reduction within a hydrogen rich zone with each of these zones comprised of a flame-like gas-phase structure, as opposed to heterogeneous combustion. This approach is used in the major commercial SCD (Agilent models 355 and 8355) and is used in competitive products. Earlier and other commercial devices like these utilize a single hydrogen rich flame-like gas-phase structure and the improvements described in the instant invention apply to these devices as well.

A commonly experienced problem with all sulfur detectors is the occurrence of active sites leading to sulfur adsorption and loss of response and this remains an active area of research and development. This is especially true of that which occurs from the deposition of silicon containing compounds from column “bleed,” elution of non-polymerized oligomers or those that form upon degradation induced by high temperature and exposure of columns to water and oxygen. In some cases, samples to be analyzed contain similar damaging species and these also negatively impact detector performance. In such cases in which performance becomes unsatisfactory, vendors claim that the expensive tube or tubes cannot be regenerated and must be replaced. Instrument down-time is inconvenient and costly. Agilent addresses this problem through utilization of a design facilitating rapid probe replacement but still at a cost of a new tube and need for recalibration.

In patent application WO 2018/048300 A2 (US 2021/0285886 A1), a furnace with similar design to the Agilent Dual Plasma furnace is described. For instance, this furnace uses an oxygen rich lower section and hydrogen rich upper section, such that two distinct combustion zones exist. The main improvement taught in that application is the ceramic surface used within the hydrogen rich zone is comprised of magnesium aluminum silicate, such as that of cordierite. The device of this application uses a furnace and ceramic tubes that are generally longer than those used in the Agilent device. As such, the inner ceramic tube is under mechanical stress because they are fixed at one end and their longer length leverages force. This is exacerbated because of the narrower tube wall compared to that of the Agilent's inner tube, and this is made even worse in this device because cordierite is inherently weaker and more brittle than alumina. Though fixing at only one end is alleviates thermally induced stresses by accommodating differences in thermal expansion of materials, breakages are possible and do occur. Nevertheless, improvements were reported for the cordierite tube relative to that of alumina; however, this application did not address the issue of loss of detector response due to column bleed or high selectivity with GC columns of normal or thin films, which results from incomplete combustion of solvents or hydrocarbons present at concentrations that are orders of magnitude higher than that of sulfur compounds present.

US patent application 2014/011993 A1 discloses improved chemiluminescence detection resulting from coating surfaces to reduce adsorption of excited species. Indeed, surrogate species to be detected tend to be reactive and thus the use of non-reactive surfaces is necessary to avoid their losses due to wall effects, and various surface washing and treatments are used to passivate or make surfaces less active. A difficulty, however, is that bulk active species may migrate to inners upon use, and even samples, carrier gases and columns can introduce active contaminants to the detector. Accordingly, one can also contemplate alternatives in which various purge gases or combustion ratios are used to minimize certain types of surface activities.

All of the previous approaches for combustion sampling for sulfur chemiluminescence detection involve the use of tubes or tubes with inlet orifices. Performance issues in these systems appear to involve efficiency of reactive species transfer and especially involve surface adsorption. Ceramic surfaces in particular are often problematic in general owing to their surface roughness, porosity and grains, all of which can behave as active sites for absorption, adsorption and detrimental catalytic reactivity and nucleation sites. In addition the aforementioned devices operate under conditions in which oxygen is the limiting reagent. This makes operation of dual combustion difficult to operate in situations where hydrogen carrier gas is used, which is currently a more common occurrence because of helium gas shortages and especially as interest grows in the use of hydrogen as a renewable fuel for combustion and fuel cell uses.

Interestingly and unexpectedly, it has been discovered that organic silicon containing compounds, appropriately placed, stabilize SO losses post-combustion sampling, thereby improving transfer efficiency and hence improve detection. Furthermore, response selectivity is unexpectedly enhanced. It is believed that stabilization results from coverage of active sites of downstream surfaces. Enhanced selectivity may result from lessened accumulation of sulfur on surfaces that can be desorbed by hydrocarbons being combusted, or it may be due to reduction of interfering matrix effects that are largely not understood.

Very surprisingly, it has been found that through proper probe construction and operating conditions, the background chemiluminescence resulting from the use of a quartz conduit in the combustion burner can be controlled and can actually improve detector sensitivity for sulfur compounds. Benner and Stedman chose to completely eliminate this background through introduction of halogen containing species, however, control of its formation is actually beneficial for improved detector performance. Attempts to controlled the background level using a metered permeation tube for chloroform exhibited an all or nothing background, i.e., fine control adjustment was not achieved. In addition, and also surprising, silicone compounds, which typically degrade detector response when introduced prior to combustion zones in the furnace, introduced at that the exit of the furnace, act to improve transfer efficiency for SO. The mechanism by which silicone compounds act to enhance detection is not clear, but it has been found that silicone tubing in combination with silicone treated end connections often yields better results than polyfluorinated polymeric tubing, e.g. Teflon® transfer lines. This is surprising given that the use of polyfluorinated polymeric tubing has been established as standard material for transfer lines in chemiluminescence analyzers for sulfur, nitrogen and nitric oxide analyzers. There are no reports of the use of silicone tubing for use in detection of gas phase free radicals or reactive species, though silicone surfaces and tubing were reportedly used in the detection of superoxide radical in aqueous solution (Milne, A., et al, Real-Time Detection of Reactive Oxygen Species Generation by Marine Phytoplankton using Flow Injection-chemiluminescence, Limnol. Oceanogr.: Methods 7, 2009, 706-715). It is known that silicone compounds readily poison many sensor devices or emit artifacts detrimental to analysis and silicone takes up carbon dioxide, so its use for sampling in many applications has been avoided.

Use of quartz at high temperature under a hydrogen rich environment as described herein results in the formation of SiO which is more reactive than SO, explaining SiO's direct chemiluminescence with oxygen. A small continuous background of SiO appears to block active sites for SO, thus facilitating its transport and detection. By controlling the background to a continuous but low level, the problem with high background as described by Benner and Stedman is eliminated and the controlled background is found to be indeed beneficial. This also avoids the need for introduction of halogen containing compounds.

This invention allows one to take advantage of inherent quartz properties of surfaces being generally smooth (low surface area) and relatively inert. In addition, quartz may be readily fashioned into intricate shapes and quartz tubing is available in almost any size, certainly many more sizes than ceramic and does not suffer from bulk active species or inhomogeneities, like ceramics possess. Also, quartz has a low coefficient of thermal expansion. Quartz is homogenous and chemically pure in contrast to ceramics which besides containing high levels of detrimental impurities, also exhibits high composition variability from batch to batch. Generally, users of ceramics for trace analysis compensate for these problems by chemically conditioning or treating the ceramic prior to its use, but these solutions are often temporary, for example deposition of silica from column bleed creates active sites on ceramic, but less so on quartz, which is itself silica.

Indeed, it has been found that generation of a low and consistent level of presumably SiO yields advantages in terms of sensitivity, rapidity of response, etc., and obviates This tube is useful for application with either outer ceramic or outer quartz tubes, i.e., such a quartz sampling probe placed within a ceramic tube is more physically robust and only a very small surface area of ceramic tube is placed within the sample path. An improved ozone destruction device embodied in the same form factor as a current commercial design has also been developed utilizing at least one filter screen placed at an acute angle (a cylinder wedge) diagonally and downstream of at least one screen placed upstream and orthogonally to the direction of flow, thereby lowering resistance to such flow and also providing a volume for accumulation of particles that minimally impedes flow, as well as preventing channeling. Furthermore, the inventive extraction probe readily accommodates hydrogen carrier gas and can be operated in a dual combustion configuration in which both zones are reducing (hydrogen rich), which has not been previously reported upon.

Further still, hydrogen reduced surfaces are reactive toward oxidized sulfur species but hydrogen rich conditions are necessary to produce and efficiently transfer SO for sensitive detection. In this regard, U.S. Pat. No. 5,153,673 (Pulsed Flame Analyzing Method and Detector Apparatus for use Therein) teaches the use of a pulsed flame for time dependent resolution of species improved spectroscopic detection of sulfur compounds. Herein it is disclosed that this approach is useful for similarly maintaining a spatial separation of surface oxidative conditions compared to gas-phase conditions, owing to faster gas-phase kinetics. Thus, it is found advantageous to pulse gases to the burner.

### BRIEF SUMMARY

Herein is disclosed an improved extraction probe, transfer line and ozone destruction device for use in chemiluminescence detection, particularly for sulfur chemiluminescence detection. These address problems of ceramic susceptibility to silica poisoning from column bleed and their use improves detector stability and sensitivity, in addition to selectivity, e.g. when thin film chromatographic stationary phases are used. These improvements are useful alone or together in any and all combinations to improve detector performance. An adapter and additional heated transfer line for coupling a detector furnace to the effluent of an FID is also described.

The quartz extraction probe is comprised of a quartz or fused silica tube containing internal Components to provide for desired turbulent flow and pressure drop. In embodiments, the internals are also comprised of quartz, smaller tubing, quartz wool, fused beads or other inert materials, such as silicon carbide. The use of quartz is also advantageous in that it is readily melted and formed into complex shapes or fused to hold internals into position. It has been found that the internals prevent high levels of background luminescent species that created high background signal interference and noise as reported by Benner and Stedman. The pressure drop provided also allows for formation of a stable reducing flame, but the pressure drop is not achieved immediately at the point of sampling but rather is somewhat downstream of it in a cooler temperature area. It has also been found that the high background may be controlled by way of modulating the hydrogen to oxygen ratios inside the burner to periodically, such as through cycling of flow, lowering the desorption of SiO and related interfering species.

The ozone destruction device utilizes an internal screen configuration producing a lower pressure drop and therefore allowing for use of an increased quantity of ozone destruction catalyst, thereby increasing its efficiency and longevity. The FID adapter allows for a heated fused silica lined tubing to sample FID exhaust gases for simultaneous hydrocarbon and sulfur detection. The inlet to the fused silica tubing is positioned perpendicularly, or at least has an orthogonal component to it, so as to minimize collection of particulates formed within the FID due to their separation by momentum. While the application is generally directed toward gas chromatography, it is applicable to supercritical and liquid chromatography as well as total sulfur detection and detection of other reactive species. The signal of the FID does not need to be collected and one might do so as the use of the FID for combustion of hydrocarbon samples is advantageous in terms of minimizing downstream combustion demands. Nevertheless, even if not used for analytical measurements, the FID signal provides diagnostic information concerning sample introduction efficiency of the analyzing using this approach.

The foregoing has outlined the features and technical advantages of the invention in order that the detailed description of the invention that follows may be better understood. Additional features and advantages will be described hereinafter that form the subject of the claims of the invention. It should be appreciated by those skilled in the art that the conception and specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a representative drawing illustrating an embodiments of a quartz probe;

FIG. 2 illustrates a transfer line of silicone tubing with sheath and boot to exclude light;

FIG. 3 illustrates an adapter that allows simultaneous FID and sulfur detection by SCD incorporating embodiments of this invention;

FIG. 4 illustrates a filtering assembly for placement within an ozone destruction device.

FIG. 5 is an illustrative chromatogram example of sensitivity and selectivity obtained from an inventive quartz probe vs. a conventional ceramic probe.

### DETAILED DESCRIPTION

This disclosure describes an improved method and extraction probe apparatus for sampling sample reactive product gas from an externally heated combustion furnace. It also describes a silicone transfer line used to efficiently transfer the combustion product gas to an ozone induced chemiluminescent reaction cell, and it describes an improvement in construction of an ozone destruction device. More particularly, it describes their implementation for sensitive and selective chromatographic detection of sulfur compounds by ozone induced chemiluminescence in which interferences are eliminated by their conversion to non-responding species, such as carbon dioxide and water, and it describes an adapter for coupling an FID to a burner using a heated transfer line.

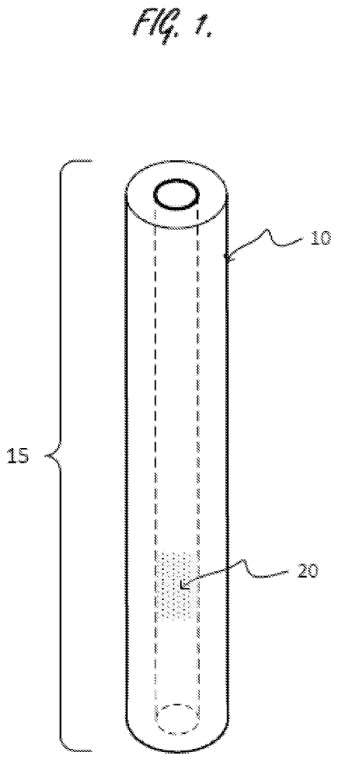

FIG. 1 is a generalized drawing of the improved extraction probe assembly 15 consisting of a quartz tube 10; and internal components 20, which in a preferred embodiment are comprised of quartz beads. The dimensions of the quartz tube are partially chosen to be accommodated within a commercial Agilent SCD burner. Most importantly, however, is the need to maintain a stable flame like structure within the immediately prior combustion zone, thus within these constraints the inventive extraction probe is readily adaptable to other dimensions for use in other manufacturers' burners.

The tube 10 has dimensions of typically ca. 110 mm length with ca. 0.5-0.7 mm internal diameter and 1.2-1.3 mm outer diameter. Longer and shorter lengths are readily accommodated and if desired the tube could be coiled, for example to aid fabrication of a smaller lower power consuming burner or if a furnace is of sufficient length to accommodate longer lengths. The fused quartz beads consisted of particles within the diameter range of 0.2 to ca. 0.4 mm that were fused into an internal bed of about 4-5 mm long bed using a hydrogen/oxygen torch using standard quartz blowing techniques. The bed 20 completely fills the space from inner wall to inner wall so as to avoid channeling. Ends are fire polished to remove sharp edges. Other embodiments utilized quartz wool held into place by dimples made within the quartz tube and silicon carbide held in place with quartz wool and still others require no internals. Relatively inert refractory materials, such as alumina, translucent alumina, sapphire, zirconia, titania and other ceramics, and refractories could be packed in place of or in combinations, e.g., with quartz to provide turbulence and pressure drop. The availability of fused silica (quartz) of various shapes and dimensions provides for greater flexibility in pressure drop across the probe compared to the availability of ceramic tubing, resulting in a more robust system of detection. Installation of the inventive probe into existing commercial furnaces or burners requires little or no modification of existing systems. Where needed, a fitting or ferrule can be drilled out to accommodate a slightly large outer diameter of the inventive probe. Seals of the probe to furnaces and burners are made conventionally with soft ferrules or o-rings. Those skilled in the art can readily optimize these dimensions and materials according to desired applications. It was found that quartz could be sealed within a protective ceramic sheath for mechanical protection at the exit of the burner, provided that the sealant of high-temperature silicone or epoxy was not exposed to temperatures exceeding about 350-400° C. This seal also serves to provide strain relief toward thermal expansion of different materials.

Some embodiments used quartz tubing by itself, blown to produce an hour glass shape or other shapes, with and without other internal components, to impart flow turbulence. It should be noted that an abrupt change in tube dimension from one size to another also introduces turbulence. The use of quartz beads, however, lends itself to relatively reproducible configurations from a manufacturing perspective. The use of removable quartz or ceramic wool against a fixed internally placed stop allows for facile testing of experimental materials. A small dead volume is created from the annular space between the inner and outer materials of the inventive probe. A small quartz capillary with dimensions of approximately 100 microns outer diameter and 7 microns inner diameter, for example, can also be inserted into this annular space to act as a shunt for sweeping this dead volume, if so desired.

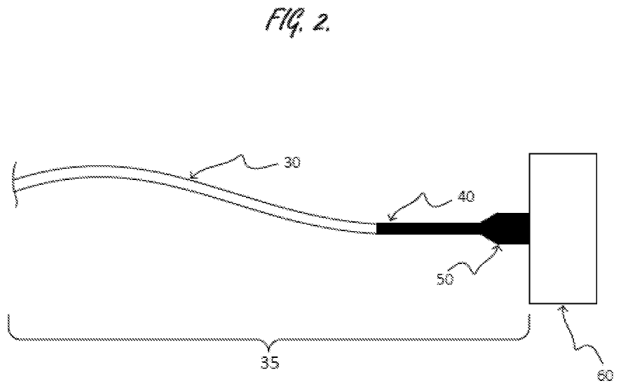

FIG. 2 illustrates a transfer line made of silicone tubing 30; with sheath 40 and boot 50 to exclude ambient light from being detected in the chemiluminescence reaction cell 60, which is comprised of machined aluminum. The sheath 40 is preferably comprised of black heat shrink tubing placed on the outside of 30, nearest 60. A length of about 25 cm is adequate when used in combination with a boot 50 that fully covers the tube connector into 60 and overlaps 40. The wall and diameter are chosen to reduce pressure drop and to resist collapse under operating vacuum. Effective outer and inner diameters are 6 mm and 3 mm, respectively.

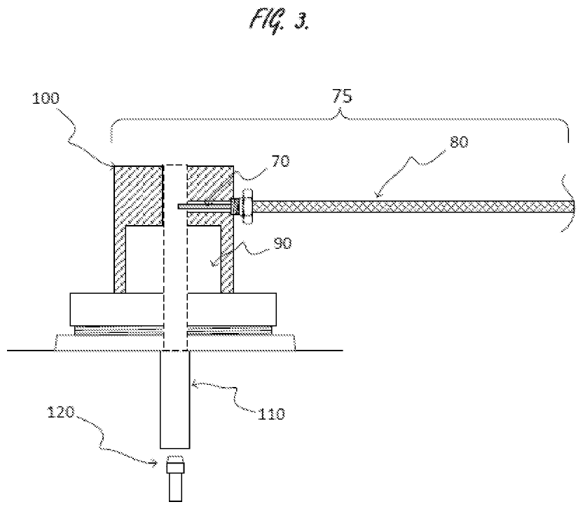

FIG. 3 is a drawing of an adapter that allows the coupling on an Agilent/Hewlett Packard FID with a burner. Components of the interface include an exhaust gas probe 70 that in embodiments is between approximately 10 and 150 cm and which is maintained at elevated temperature of about 65-100° C. by an electrically heated transfer line 80. In embodiments, the length of 70 and 80 are about 60 cm and controlled to about 90° C. and 70 is comprised of fused silica capillary or fused silica lined metal capillary with an internal diameter of 0.53 mm (a standard dimension for fused silica capillary tubing). The capillary has a deactivation layer consisting of polydimethylsiloxane polymer, for example with a 7 μm thickness. Exhaust gas probe 70 is positioned approximately in the center and perpendicularly within the gas flow exhaust of the FID collector 100 through with the combusted gases exit from the chimney 90 that originate at jet 110 of the FID. The adapter housing 120, fastens to the FID chimney 90. The flow collected is a fraction of the FID flow rate, from about 20-40% depending on the total flow through the FID and the length of the 70.

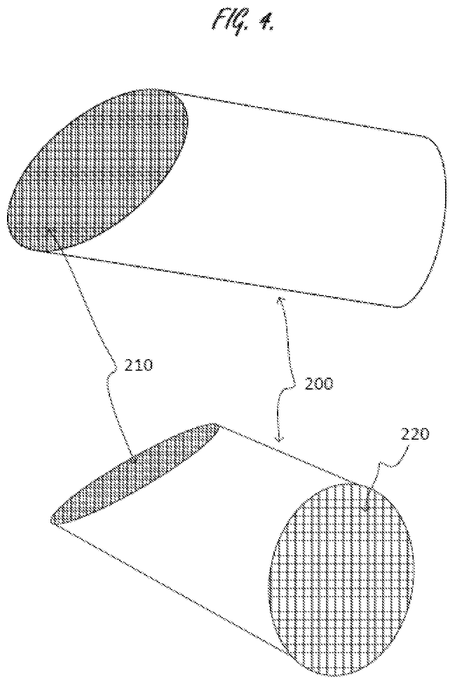

Particulates consisting of ozone destruction catalyst fines are formed through normal abrasion processes. They must be trapped to prevent them from damaging the detector's vacuum pump. FIG. 4 is a drawing of a cylindrical filter assembly 200 that consists of an open cylinder upon which a downstream cylindrical wedge elliptical screen 210 and an upstream perpendicular circular screen 220. The body of the cylinder is comprised of any material that is stable to ozone exposure over a long period, such as stainless steel, copper, PVC, and upon which screens are readily affixed using an adhesive. The upstream screen 220 is more open (lower mesh) and the downstream screen 210 is less open (higher mesh). Pressure drop is minimized because the elliptical screen has a greater surface area than a circular cross section. The acute angle formed by the elliptical screen and the cylinder body provides a volume for collection of particulates that pass through the larger spaces of the perpendicular screen and settle in corners or where space velocity is low.

### EXAMPLES

Combustion extraction probes were produced within the ranges of dimensions and materials of composition as described in the foregoing. Results from the extraction probe embodiments of this invention were compared against those obtained from conventional, commercial ceramic tubes. Consistent with the literature, it was found that all quartz tubular probe construction was ineffective because of a large background signal that grew over time and they exhibited unstable response. In fact, with all quartz single straight tubes tested, in only a few minutes the background noise because so high (off-scale) so as the render the signal unusable, even though in the first minute or few minutes response to sulfur was also high. Embodiments of this invention in which internals were added to quartz tubes or another tube was used to surround the inner tube were found to be available commercial burner inner ceramic tubes. Owing to several desirable properties in terms of inertness, low surface area, low thermal expansion and ease with which its shape is modified, quartz tubing is deemed a preferred embodiment for this invention. Deposition of an inert surface, such as silica by way of chemical vapor means, may provide similar benefit provided that the surface is mechanically and chemically sound.

Probes were tested with and without silicone transfer lines and with an improved ozone destruction device. Since silicone transfer lines and improved ozone destruction devices led to equal or improved performance for all extraction probes, this reduced the number of combinations of experiments required for investigation. For heated transfer line control from the FID adapter, a variable transformer was used to conveniently apply voltage to a Watlow flexible tube heater. Little or no advantage was found for heating the silicone transfer line to the chemiluminescent cell, at least for sulfur detection.

### Example 1

An extraction probe was prepared using a 100 mm length with ca. 0.5-0.7 mm internal diameter and 1.2-1.3 mm outer diameter, ID alumina ceramic tube of 118 mm length. A Hewlett Packard model 5890 Series II Gas Chromatograph was used for this work throughout. The SCD was a Sievers model 350B with a modified Agilent Dual Plasma burner and controller. Air was used for the ozone generation with its inlet pressure set to 3 psig. The column was a 15 m, 0.32 mm ID, SPB-1 with a 4 μm film thickness. The head pressure was 7 psig with nitrogen carrier with a split ratio of 1:10 and oven temperature program of 40° C. for 1 minute to 120° C. at 10° C./min, hold 1 minute. The SCD furnace was operated at 800° C. with hydrogen and air flows of 130 and 5 mL/min, respectively. Prior to operation, the average peak to peak noise was arbitrarily set to 0.0 mvolt. After stabilization for several minutes, with oxygen flowing to the ozone generator, the average peak to peak noise was measured at 0.1 mVolt and with the ozone generator energized it measured 0.6 mVolt. This indicates the presence of SiO, which chemiluminesces with ground-state oxygen. The system using the inventive probe exhibited fast start-up times capable of generating qualitative and semi-quantitative results in a manner of minutes, faster than conventional probes.

### Example 2

Probes were examined under conditions of hydrogen flow to the burner about 80 mL/min and air flow rate about 90 mL/min. The SCD furnace was operated at 800° C. and a 30 m, 0.32 mm ID, DB-1 with a 2 μm film thickness was used. The head pressure was 12 psig (nitrogen) with a split ratio of 1:10 and oven temperature program of 50° C. for 0.5 minutes to 280° C. at 12° C./min, hold 1 minute. The column and conditions used generated significant bleed (siloxanes). Superior performance of the inventive extraction probe was observed by comparison to other constructions as shown by results summarized in Table 1 (qualified by sensitivity, selectivity and stability). Excellent results obtained from the invention described herein were unexpected. The combination of a treated ceramic tube at the point of flame/plasma formation and in the nearby quench zone, along with a liner as described are capable of producing superior performance. The inventive extraction probe is also resistant to hydrogen poisoning, whereas the conventional commercial probe is not.

TABLE 1

| Example | Sensitivity | Selectivity | Stability |
|---|---|---|---|
| Inventive Quartz Probe* | Good | Good | Good |
| Quartz Probe - By | Good** | Fair | Poor |
| itself with Internals | | | |
| Commercial Probe | Good | Good | Fair |

*Quartz tube(s) with internals and/or outer protection
**Unusable almost immediately due to high noise

### Example 3

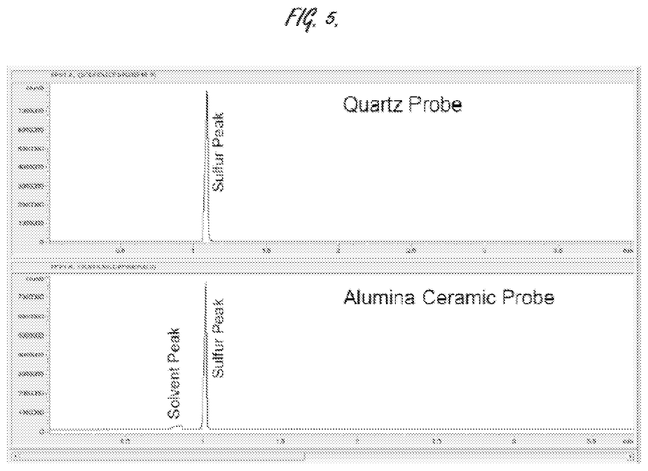

Using conditions typical of convention dual plasma SCD, FIG. 5 is an example chromatogram of sensitivity and selectivity obtained from an inventive quartz probe vs. conventional commercial ceramic probe, showing improved performance for the inventive probe. Peak shape obtained is excellent and no difference in shape was observed using a shunt to sweep any annular space dead volume.

### Example 4

Using the conditions typical of a single plasma SCD, for example, operating at 780° C. with an initial hydrogen flow rate of 60 mL/min and oxygen flow rate of 8 mL/min. Following ignition of the burner, as evidenced by a sudden rise in the baseline, then a gradual fall was observed over about 5 minutes, the detector baseline began to rise continuously from about 0.3 mV to over 50 mV, at which point the hydrogen flow rate was lowered to 30 mL/min with an immediate fall in the baseline to about 2 mV. The baseline signal was monitored and the hydrogen flow rate was adjusted up to 34 mL/min in multiple steps so that the baseline signal was steady. Alternatively, a solenoid valve was placed on the hydrogen line to the burner with hydrogen flow rate set to 60 mL/min and oxygen flow rate of 8 mL/min. A cyclic timer was used to actuate the solenoid valve continuously at nominally 10 Hz, a rate faster than the signal peak width by at least a factor of 2 or 3. Because the hydrogen flow is momentarily interrupted at each cycle, total hydrogen consumption was reduced but surprisingly a factor of 2 improvement in signal is observed with slight improvement in peak shape because surface reactivity is diminished. Addition of a low flow rate of gas, for example air or oxygen from about 1 to 15 mL/min, preferably closer to 1 mL/min, provided an even slightly better peak shape without significant loss in signal.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide exemplary, procedural or other details supplementary to those set forth herein.

I claim:

1. An improved method for sulfur chemiluminescence detection comprising a multicomponent combustion gas extraction probe for collection and transfer of reactive species for their detection, whereby an inner component of the probe consists of an inert refractory and an outer component is a refractory material.

2. An apparatus for sulfur chemiluminescence detection comprising:
a. a dual combustion zone burner;
b. a chemiluminescence reaction cell;
c. a vacuum pump; and
d. a multicomponent combustion gas extraction probe for collection and transfer of reactive species for their detection, whereby an inner component of the probe consists of an inert refractory and an outer component is a refractory material.

3. The improved method of claim 1, further comprising:
a. a dual combustion zone burner;
b. a chemiluminescence reaction cell; and
c. a vacuum pump.

4. The apparatus according to claim 2, whereby the inner component contains wool, beads, or other features to induce turbulence and pressure drop.

5. A apparatus according to claim 2, whereby a change in inner dimensions of the probe induces turbulence.

6. The method of claim 3, further comprising a quartz probe and components to increase sample signal and reduce background noise.

7. The method of claim 6, further characterized by improving the analysis of sulfur compounds in a sample.

8. The method in claim 3 wherein the active species from a flame or plasma utilizing a quartz probe and components to eliminate interfering background chemiluminescence by means of surfaces to allow some survival of an active species (SiO) to facilitate high transport efficiency of SO.

9. The method in claim 3 wherein operating conditions are adjusted to maintain a consistent low level of background noise commensurate with high detector sensitivity and stability.

10. The method in claim 3 wherein a silicone-based transfer line is used from the burner to the chemiluminescence reaction cell.

11. The method in claim 3 wherein an ozone destruction catalyst assembly with lower pressure drop and improved means for trapping particulates is used between the chemiluminescence reaction cell and the vacuum pump.

12. The method in claim 3 wherein the dual combustion zone burner is operated with two hydrogen-rich reducing-zones.

13. The method in claim 3 wherein burner gas flows to the dual combustion zone burner are cyclically pulsed or modulated.
